(19) United States
(12) Patent Application Publication
(10) Pub. No.: US 2002/0159655 A1
(43) Pub. Date: Oct. 31, 2002

(54) Apparatus and method of using scaling device of pre-filter

(76) Inventor: Kun-Nan Cheng, Hsinchu (TW)

Correspondence Address: J.C. Patents, Inc., Suite 114, 1340 Reynolds Ave., Irvne, CA, 92614, US

(21) Appl. No.: 09/871,355

(22) Filed: May 31, 2001

(30) Foreign Application Priority Data
Apr. 30, 2001 (TW) 90110252

(51) Int. Cl. G06T 3/40; G09G 5/373

(52) U.S. Cl. 382/299; 345/660

(57) ABSTRACT

A scaling device and a scaling method that employs a pre-filter. Using a pre-filter instead of a post-filter and a data storage unit as in a conventional device, scaling quality of the device is improved and production cost of the device is reduced. The scaling device includes a pre-filter for receiving data columns and carrying out chromatic adjustment and a scaling process for receiving the adjusted data and producing scaled data.

### CROSS-REFERENCE TO RELATED APPLICATION

This application claims the priority benefit of Taiwan application serial no. 90110252, filed Apr. 30, 2001.

### BACKGROUND OF THE INVENTION

1. Field of Invention

The present invention relates to an apparatus and method of using a scaling device. More particularly, the present invention relates to an apparatus and method of using the scaling device of a pre-filter.

2. Description of Related Art

In computer graphics, scaling is a process of enlarging or reducing an image (such as a pattern or a text). After a scaling, size of the image is changed but the original shape is retained. Scaling is a useful method for enhancing or shrinking image patterns, video signals, voice signals, digital signals and processing any changes in the resolution of multimedia. In particular, for a fixed resolution digital display device, image format from different source must be scaled before the image can be shown in an appropriate resolution that matches a given display device.

FIG. 1 is a schematic block diagram showing a conventional scaling system that employs a post-filter. The scaling device in FIG. 1 includes a scaling engine 102, a data storage unit 200 and a post-filter 104 all interconnected together. For a post-filter 104 capable of processing N data columns with each column having M data points, filtering can only be conducted after a plurality of batches of scaled data is input. Hence, the subsidiary data storage unit 200 for data storage is essential. With the data storage unit 200 in place, the post-filter 104 can concurrently receive multiple batches of data for initiating a filtering operation. However, a major drawback is the high cost for providing the data storage unit 200.

### SUMMARY OF THE INVENTION

Accordingly, one object of the present invention is to provide a scaling device that uses a pre-filter instead of a post-filter while still using a data storage unit as in a conventional device. Ultimately, scaling quality of the device is improved and production cost of the device is reduced.

To achieve these and other advantages and in accordance with the purpose of the invention, as embodied and broadly described herein, the invention provides a scaling device that uses a pre-filter. The pre-filter receives N data columns. After chromatic adjustment, the pre-filter outputs P data columns to the scaling processor for scaling. The scaling processor later output scaled data. Each of the N data columns includes M factors, where 1<P≦N and M, N and P are positive integers. The pre-filter includes a first operational amplifier, a second operational amplifier, a third operational amplifier and a fourth operational amplifier. The first operational amplifier receives the N data columns and generates data K, where data K=[D_{1M/2}; D_{2M/2}, D_{3M/2}, . . . D_{PM/2}; and data D_{PM/2} is the M/2^{th} data of the P^{th} data column.

The second operational amplifier receives the N data columns and generates a weighed function W and a coefficient factor C, where the weighed function is W=[W₁; W₂; W₃; . . . W_{P};] and the coefficient factor is C=[C₁₁, C₁₂C₁₃ . . . C_{1M}; C₂₁, C₂₂, C₂₃ . . . C_{2M}; . . . ; C_{N1}, C_{N2}, C_{N3}, . . . C_{NM};]. The weighed function W, is the weighed function of the P^{th} data column and the coefficient factor C_{NM} is the coefficient of the M^{th} data in the N^{th} data column, where W can be any value.

The third operational amplifier is coupled to the second operational amplifier for receiving the N data column and generating data D and data FLT, wherein the data D=[D₁₁, D₁₂D₁₃ . . . D_{1M}; D₂₁, D₂₂, D₂₃ . . . D_{2M}; . . . ; D_{N1}, D_{N2}, D_{N3}, . . . D_{NM}; and the data FLT=_{n=1 . . . N,m=1 . . . M}Σ(Cₙₘ×Dₙₘ). The data D_{NM} is the M^{th} data in the N^{th} data column, the coefficient Cₙₘ is the coefficient of the m^{th} data in the n^{th} data column and the data Dₙₘ is the m^{th} data in the n^{th} data column.

The fourth operational amplifier is coupled to the first operational amplifier, the second operational amplifier, the third operational amplifier and the scaling processor. The fourth operational amplifier receives data from the first, the second and the third operational amplifier and generates a data column FO, where the data column FO=[FO₁; FO₂; FO₃; . . . FOₚ;] and FO_{n=1 p}=Wₙ×FLT+(1−Wₙ)×Kₙ, and FOₚ represents the output data of the p^{th} column.

This invention also provides a method of using the pre-filter. The N data columns are chromatically adjusted by the pre-filter to generate P reduced or enhanced data columns. The scaled data is passed to the scaling processor to produce scaled data. Each of the N data columns includes M factors, where 1<P≦N and P, M and N are positive integers.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic block diagram showing a conventional scaling system that employs a post-filter;

FIG. 2 is a schematic block diagram showing a scaling device with a pre-filter according to one preferred embodiment of this invention;

FIG. 3 is a detailed block diagram of the pre-filter shown in FIG. 2; and

FIG. 4 is a block diagram showing the type of data generated by various operational amplifiers shown in FIG. 3.

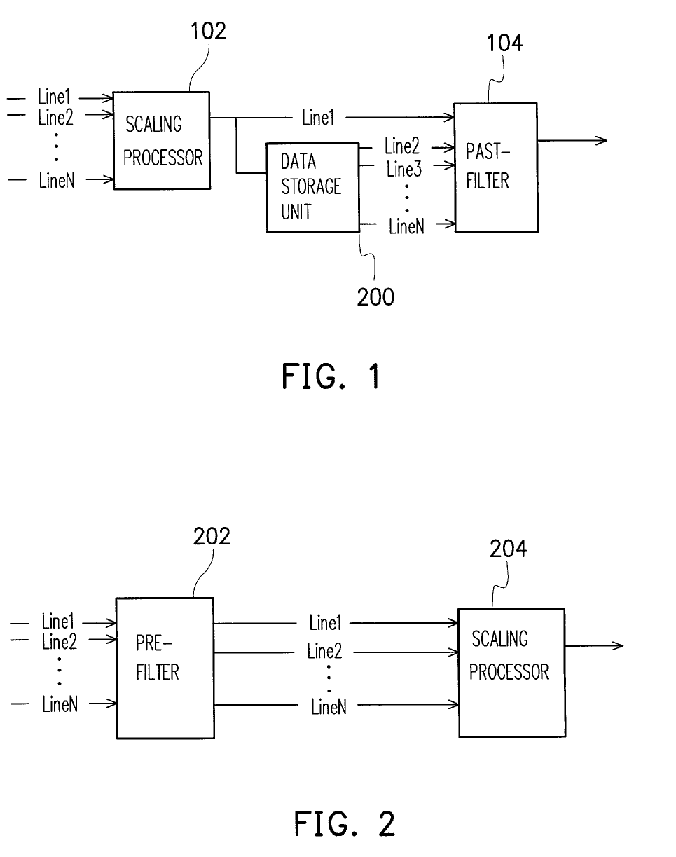

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

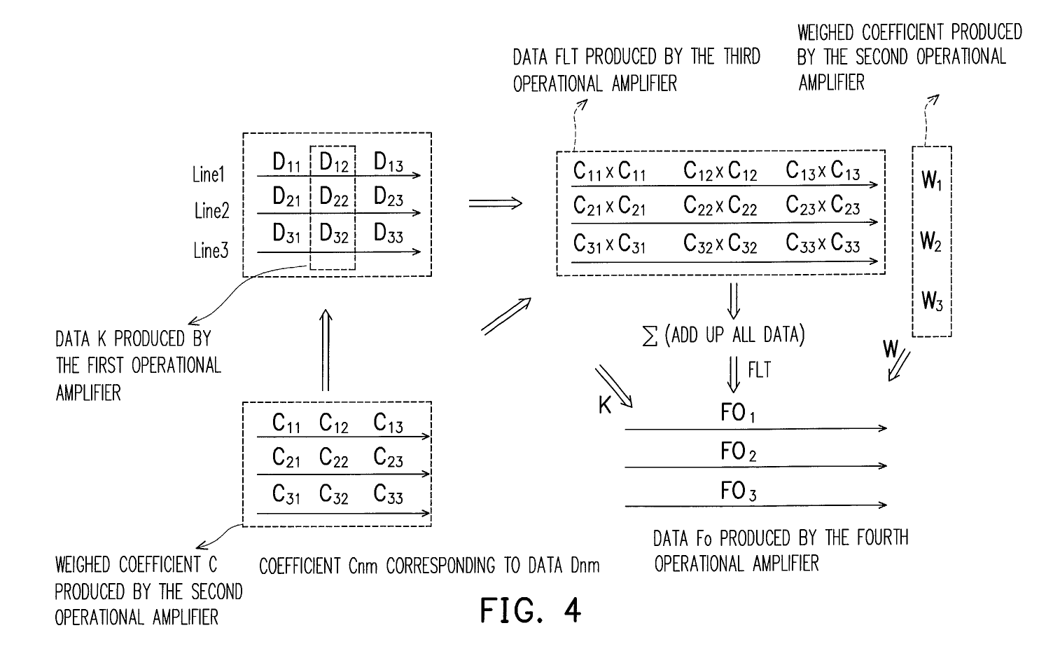

FIG. 2 is a schematic block diagram showing a scaling device with a pre-filter according to one preferred embodiment of this invention. In this embodiment, a pre-filter 202 receives three data columns and each data column includes three pieces of data. As shown in FIG. 4, the first data column includes data D₁₁, data D₁₂ and data D₁₃, the second data column includes data D₂₁, data D₂₂ and data D₂₃ and the third data column includes data D₃₁, data D₃₂ and data D₃₃. The pre-filter 202 receives these three data columns and performs a chromatic adjustment of the data. The adjusted data is output to a scaling processor 204 for scaling treatment.

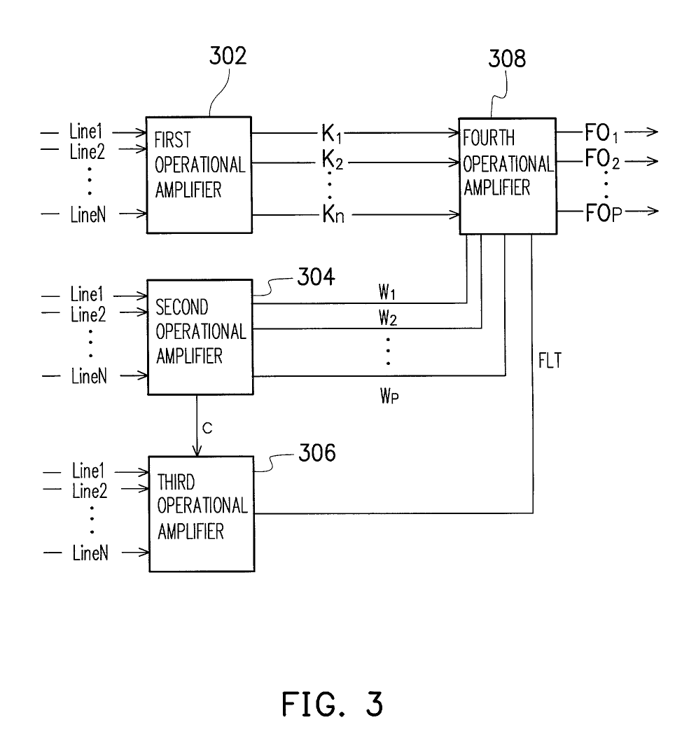

FIG. 3 is a detailed block diagram of the pre-filter shown in FIG. 2. As shown in FIG. 3, a first operational amplifier 302 receives the three data columns and generates data K, where data K=[D₁₂, D₂₂, D₃₂]. A second operational amplifier 304 receives the three data columns and generates a weighed function and a coefficient C, where W=[W₁, W₂, W₃] and C=[C₁₁, C₁₂, C₁₃; C₂₁, C₂₂, C₂₃; C₃₁, C₃₂, C₃₃]. A third operational amplifier 306 receives the three data columns and generates data D and data FLT, where FLT=[C₁₁D₁₁+C₁₂D₁₂+C₁₃D₁₃+C₂₁D₂₁+C₂₂D₂₂+C₂₃D₂₃+C₃₁D₃₁+C₃₂D₃₂+C₃₃D₃₃]. A fourth operational amplifier 308 is coupled to the first operational amplifier 302, the second operational amplifier and the third operational amplifier 306 and the scaling processor. The fourth operational amplifier 308 receives data from the first operational amplifier 302, the second operational amplifier 304, the third operational amplifier 306 and generates data FO, where FO=[FO₁; FO₂; FO₃].

FIG. 4 is a block diagram showing the type of data generated by various operational amplifiers shown in FIG. 3. As shown in FIG. 4, the first operational amplifier in the pre-amplifier generates data K, where K=[D₁₂, D₂₂, D₃₂]. Thereafter, the second operational amplifier generates a weighed function W and a coefficient C, where W=[W₁, W₂, W₃] and C=[C₁₁, C₁₂, C₁₃; C₂₁, C₂₂, C₂₃; C₃₁, C₃₂, C₃₃] Next, the third operational amplifier generates data FLT, where FLT=[C₁₁D₁₁+C₁₂D₁₂+C₁₃D₁₃+C₂₁D₂₁+C₂₂D₂₂+C₂₃D₂₃+C₃₁D₃₁+C₃₂D₃₂+C₃₃D₃₃]. Finally, the fourth operational amplifier receives data from the first, the second, the third operational amplifier and generates data FO=[FO₁; FO₂; FO₃], where FO₁=W₁×FLT+(1−W₁)×K₁, K₁=[D₁₂], W₁is any number; FO₂=W₂×FLT+(1−W₂)×K₂, K₂=[D₂₂], W₂is any number; and FO₃=W₃×FLT+(1−W₃)×K₃, K₃=[D₃₂], W₃is any number. Finally, the pre-filter outputs data columns FO₁, FO₂ and FO₃ to the scaling processor to produce scaled data.

In summary, this invention uses a scaling device having a pre-filter instead of a post-filter and a data storage unit as in a conventional device. Hence, scaling quality of the device is improved and production cost of the device is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A scaling device, comprising:
a pre-filter for receiving N data columns and outputting data after chromatic adjustment, wherein each of the N data columns includes M data sets, where M and N are a positive integers; and
a scaling processor coupled to the pre-filter for receiving output data from the pre-filter and generating scaled data.

2. The scaling device of claim 1, wherein the pre-filter further includes:
a first operational amplifier for receiving the N data columns and generating data K=[D_{1M/2}; D_{2M/2}, D_{3M/2}, . . . D_{PM/2};] and data D_{PM/2} is M/2^{th} data of the P^{th} data column, wherein data K can be represented by other symbols or methods of representation;
a second operational amplifier for receiving the N data columns and generating a weighed function W and a coefficient factor C, where the weighed function W [W₁; W₂; W₃; . . . W_{P};] and the coefficient factor C=[C₁₁, C₁₂C₁₃ . . . C_{1M}; C₂₁, C₂₂, C₂₃ . . . C_{2M}; . . . ; C_{N1}, C_{N2}, C_{N3}, . . . C_{NM};] and a weighed function W_{N} is a function of the N^{th} data column and the coefficient factor C is a coefficient of M^{th} data in the N^{th} data column and W can have any value, wherein the weighed function W and the coefficient C can be represented by other symbols or methods of representation;
a third operational amplifier coupled to the second operational amplifier for receiving the N data column and generating data D and data FLT, where the data D=[D₁₁, D₁₂D₁₃ . . . D_{1M}; D₂₁, D₂₂, D₂₃ . . . D_{2M}; . . . ; D_{N1}, D_{N2}, D_{N3}, . . . D_{NM};] and the data FLT=_{n=1 . . . N,m=1 M}Σ(Cₙₘ×Dₙₘ), the data D_{NM} is the M^{th} data in the N^{th} data column, a coefficient Cₙₘ is a coefficient of the m^{th} data in the n^{th} data column and the data z,900 is the m^{th} data in the n^{th} data column, wherein data D and data FLT can be represented by other symbols or methods of representation; and
a fourth operational amplifier coupled to the first operational amplifier, the second operational amplifier, the third operational amplifier and the scaling processor for receiving data from the first, the second and the third operational amplifier and generating a data column FO, where the data column FO=[FO₁; FO₂; FO₃; . . . FO_{P};] and FO_{n=1 P}=Wₙ×FLT+(1−W)×Kₙ, and FOₙ represents output data of the n^{th} column, wherein data FO can be represented by other symbols or methods of representation.

3. A scaling method that employs a pre-filter for chromatic adjustment, comprising the:
the pre-filter receives N data columns and generates P data columns of enhanced or reduced columns after chromatic adjustment; and
a scaling processor receives the P data columns and generates scaled data;
wherein each of the N data column includes M factors, where 1<P≦N and P, M and N are positive integers.

4. The scaling method of claim 3, wherein performing chromatic adjustment further includes:
receiving the N data columns to generate data K, where data K=[D_{1M/2}; D_{2M/2}; D_{3M/2}; . . . D_{PM/2};] and data D_{PM/2} is M/2^{th} data of p^{th} data column, wherein data K can be represented by other symbols or methods of representation;
receiving the N data columns and generating a weighed function W and a coefficient factor C, where the weighed function W=[W₁; W₂; W₃; . . . W_{P};] and the coefficient factor C=[C₁₁, C₁₂C₁₃ . . . C_{1M}; C₂₁, C₂₂, C₂₃ . . . C_{2M}; . . . ; C_{N1}, C_{N2}, C_{N3}, . . . C_{NM};], the weighed function W_{P} is a function of the P^{th} data column and the coefficient factor C is coefficient of the M^{th} data in the N^{th} data column and W can have any value, wherein the weighed function W and the coefficient C can be represented by other symbols or method of representation;
receiving the N data column and generating data D and data FLT, where the data D=[D₁₁, D₁₂D₁₃ . . . D_{1M}; D₂₁, D₂₂, D₂₃ . . . D_{2M}; . . . ; D_{N1}, D_{N2}, D_{N3}, . . . D_{NM};] and the data FLT=_{n=1 . . . N,m=1 M} Σ(Cₙₘ×Dₙₘ), the data D_{NM} is the M^{th} data in the N^{th} data column, coefficient Cₙₘ is a coefficient of m^{th} data in the n^{th} data column and the data Dₙₘ is the m^{th} data in the nth data column, wherein data D and data FLT can be represented by other symbols or methods of representation; and
receiving data K, weighed function W and data FLT and generating a data column FO, where the data column FO=[FO₁; FO₂; FO₃; . . . FO_{P};] FO_{n=1 . . . P}=Wₙ×FLT+(1−Wₙ)×Kₙ, and FOₙrepresents output data of the n^{th} column, wherein data FO can be represented by other symbols or methods of representation.

5. The scaling method of claim 3, wherein the method is applicable for processing image patterns, video signals, voice signals, digital signals and the scaling of multimedia.

6. The scaling of claim 3, wherein the method is applicable for enlarging or shrinking data.
